(19) United States
(12) Patent Application Publication
(10) Pub. No.: US 2011/0267949 A1
(43) Pub. Date: Nov. 3, 2011

(54) QUALITY OF SERVICE-PROVIDING SYSTEM AND METHOD FOR PROVIDING QUALITY OF SERVICE IN THE SYSTEM

(76) Inventors: Nam-Seok Ko, Daejeon (KR); Sung-Back Hong, Daejeon (KR); Bong-Tae Kim, Daejeon (KR); Kyeong-Ho Lee, Daejeon (KR)

(21) Appl. No.: 13/141,393

(22) PCT Filed: Sep. 17, 2009
(86) PCT No.: PCT/KR09/05301

§ 371 Date: Jun. 22, 2011

(30) Foreign Application Priority Data
Dec. 22, 2008 (KR) 10-2008-0131619

(51) Int. Cl. H04W 28/16

(52) U.S. Cl. 370/235

(57) ABSTRACT

There are provided a quality of service (QoS)-providing system and a method for providing quality of service for mobile nodes in the QoS-providing system. Under a network environment running a host-based network layer mobility protocol based on tunneling mechanism, the QoS-providing system may be useful to allow effective mobility supports by distributing binding information to the distributed nodes, in order to provide session-based quality of service for tunneled packets between the mobile nodes on the access nodes and distribute traffic load concentrated on the central mobility control platform as well. Also, the QoS-providing system according to one exemplary embodiment of the present invention may be useful to provide the function of hiding locations of mobile nodes since a care-of address of the mobile node is not transferred to a correspondent node and to automatically perform a route optimization procedure even when the mobile node does not directly perform a route optimization procedure.

### TECHNICAL FIELD

The present invention relates to a quality of service (QoS)-providing system and a method for providing quality of service for mobile nodes in the system, and more particularly, to a system for providing session-based quality of service for traffic between the mobile nodes under a network environment running a host-based network layer mobility protocol based on tunneling mechanism, and a method for providing quality of service in the system.

### BACKGROUND ART

Generally, network layer mobility protocols that operate based on the tunneling mechanism encapsulate the original IP packets having addresses that an actual application used in a node uses with addresses that are allocated according to its current location. Here, the source address used by the actual application is an address that is continuously maintained regardless of the movement of nodes such as home address (HoA).

Therefore, normally conventional routers cannot identify actual sessions that applications are using if they do not use any special mechanism to look inside the packet payload, but instead regards all the traffic between two different nodes as one session.

Also, the conventional technologies have problems in that when nodes move and are not subject to an optimization procedure, all the traffic of the nodes are delivered via an anchoring mobility control platform such as a home agent (HA), which leads to an increased load in the anchoring mobility control platform.

### DISCLOSURE OF INVENTION

### Technical Problem

The present invention is designed to solve the problems of the prior art, and therefore it is an object of the present invention to provide a quality of service (QoS)-providing system capable of providing session-based QoS for traffic between the mobile nodes under a network environment running a host-based network layer mobility protocol based on tunneling mechanism, and a method for providing quality of service for mobile nodes in the system.

Also, it is another object of the present invention to provide a QoS-providing system capable of distributing traffic load which is concentrated on an anchoring mobility control platform under a network environment running a host-based network layer mobility protocol based on tunneling mechanism, and a method for providing quality of service for mobile nodes in the system.

### Solution to Problem

According to an aspect of the present invention, there is provided a method for providing quality of service for mobile nodes in a quality of service (QoS)-providing system including a central mobility control platform and a plurality of access nodes providing access to a plurality of nodes under a network environment running a host-based network layer mobility protocol based on tunneling mechanism, wherein any of the access nodes provide quality of service for traffic between the plurality of nodes, the method includes: performing a binding update process for a mobile node to generate binding information by the central mobility control platform; distributing the binding information to a plurality of access nodes by the central mobility control platform; forwarding a packet to an access node providing access to the mobile node using the distributed binding information after processing session-based QoS by an access node providing access to a correspondent node when the packet is received from the correspondent node; and forwarding the packet to the mobile node using the distributed binding information after processing session=based QoS by the access node providing access to the mobile node.

According to another aspect of the present invention, there is provided a quality of service (QoS)-providing system including a plurality of access nodes distributed-providing forwarding for a packet transferred between nodes and processing quality of service for the packet; and a central mobility control platform updating binding information received from a mobile node to set a tunnel with the mobile node and distributing binding information of the mobile node to the plurality of access nodes.

### ADVANTAGEOUS EFFECTS OF INVENTION

As described above, the QoS-providing system according to one exemplary embodiment of the present invention may be useful to allow effective mobility supports since the QoS-providing system may provide session-based quality of service for tunneled packets and also distribute traffic concentrated on the central mobility control platform.

Also, the QoS-providing system according to one exemplary embodiment of the present invention may be useful to provide the function of hiding positions of mobile nodes since a care-of address of the mobile node is not transferred to a correspondent node and to automatically perform a route optimization procedure even when the mobile node does not directly perform a route optimization procedure.

### BRIEF DESCRIPTION OF DRAWINGS

FIG. 1 is a diagram illustrating a configuration of a QoS-providing system for providing quality of service (QoS) for mobile nodes under a network environment running a host-based network layer mobility protocol based on tunneling mechanism according to exemplary embodiments of the present invention.

FIG. 2 is a diagram illustrating a method for providing session-based quality of service when a mobile node communicates with a moving correspondent node under a network environment running a host-based network layer mobility protocol based on tunneling mechanism according to one exemplary embodiment of the present invention.

FIG. 3 is a diagram illustrating a method for providing session-based quality of service when a mobile node communicates with a fixed correspondent node under a network environment using a host-based network layer mobility protocol based on tunneling mechanism according to another exemplary embodiment of the present invention.

FIG. 4 is a diagram illustrating a packet type used in the method for providing session-based quality of service according to one exemplary embodiment of the present invention.

FIG. 5 is a diagram illustrating a packet type used in the method for providing session-based quality of service according to another exemplary embodiment of the present invention.

### BEST MODE FOR CARRYING OUT THE INVENTION

Hereinafter, exemplary embodiments of the present invention will be described in detail with reference to the accompanying drawings. For the exemplary embodiments of the present invention, detailed descriptions of known functions and constructions that are related to the present invention are omitted for clarity when they are proven to make the gist of the present invention unnecessarily confusing.

In accordance with exemplary embodiments of the present invention, there is described an application to a communication system under a network environment running a host-based network layer mobility protocol in which packets are forwarded after being encapsulated with a care-of address of a mobile node allocated separately according to the network topology without any changes in a home addresses of the mobile node.

First of all, a configuration of a network for providing quality of service (QoS) for mobile nodes, based on this communication system, according to exemplary embodiments of the present invention is described in more detail with reference to the accompanying drawings.

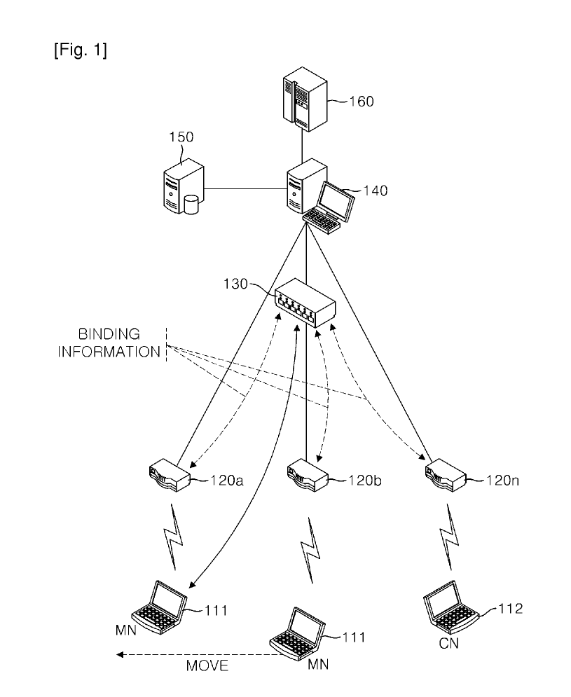

FIG. 1 is a diagram illustrating a configuration of a QoS-providing system for providing quality of service (QoS) for mobile nodes under a network environment running a host-based network layer mobility protocol based on tunneling mechanism according to exemplary embodiments of the present invention.

Referring to FIG. 1, the QoS-providing system may include a plurality of mobile nodes 111 and 112, a plurality of access nodes 120, a central mobility control platform (CMCP) 130, a QoS control server 140, a subscriber profile database 150 and an application server 160.

As shown in FIG. 1, the plurality of nodes 111 and 112 are shown as a mobile node (MN) 111 and a correspondent node (CN) 112, respectively, which attempt to communicate with each other. Here, it may be assumed that the mobile node 111 supports a tunneling-based mobility protocol, and that the correspondent node 112 supports or does not support the mobility protocol.

The mobile nodes 111 and 112 move to exchange a control message with the central mobility control platform 130, forward binding information of their own home addresses (hereinafter, referred to as HoA) and care-of addresses (hereinafter, referred to as CoA) to the central mobility control platform 130, and update the binding information. The correspondent node 112 sets its own binding information to the central mobility control platform 130. Therefore, the central mobility control platform 130 distributes the set binding information to each of access nodes 120a to 120n.

The access nodes 120a to 120n are nodes (DFQ: Distributed Forwarding QoS) that provide network access to the mobile nodes 111 and 112 to support the mobility of the mobile nodes 111 and 112 and provide quality of service for the received packets and forward the received packets, and include a forwarding table (not shown) and a quality of service table (not shown). Such access nodes 120 receive the binding information for the mobile nodes 111 and 112, and then add a forwarding entry for the home address (HoA) of a mobile node 110 to the forwarding table.

Then, the access nodes 120 decapsulate all tunneling packets in which an address of the central mobility control platform 130 and addresses of the other access nodes 120 are set as destination addresses and transferred, processes the decapsulated tunneling packets according to the results of forwarding table lookup and QoS table lookup using an inner header, and then transfer the processed tunneling packets. Here, a different kind of binding information is transferred to the access node 120a to which the mobile node 111 is attached, and the other access nodes 120b to 120n, respectively. That is, the access node 120a to which the mobile node 111 is directly attached transfers CoA information of the mobile node 111 with HoA information of the mobile node 111 as its binding information, and the other access nodes 120b to 120n does not transfer the CoA information of the mobile node 111 but instead an address of the access node 120a to which the mobile node 111 is attached as the binding information.

Also, when a forwarding table is searched for the packets decapsulated at the access nodes 120a to 120n. if there is information about destinations on the forwarding table, a packet is encapsulated with a corresponding destination address, and then transferred. On the contrary, if there is no information about destinations, a packet is encapsulated into an original packet header, and then transferred. That is, in the case of previously registered nodes such as the correspondent node 112, a packet is encapsulated with an address of an access node 120n to which the correspondent node 112 is attached, and then transferred, but in the case of nodes that are not previously registered, a packet is encapsulated into an original packet header, and then transferred.

The central mobility control platform 130 controls the mobility protocol in the center. Here, when the central mobility control platform 130 receives a binding update message requested from the mobile node 111, it distributes the binding information obtained from the binding update message to access nodes 120a to 120n, and sets a tunnel with the mobile node 111.

The QoS control server 140 distributes the forwarding load on the mobile node 111, controls application sessions in order to provide session-based QoS for the application traffic from the mobile node 111, obtains information of the application sessions from a subscriber, and links the obtained information with information in subscriber profiles.

The subscriber profile database 150 stores the information in subscriber profiles.

The application server 160 is an SIP server that manages the information of the application sessions from the subscriber, and provides the session-based QoS to the central mobility control platform 130 and the access nodes 120 via a QoS-providing server.

Next, a method for providing quality of service (QoS) under a network environment using a host-based network layer mobility protocol based on tunneling mechanism in the network for providing quality of service (QoS) according to one exemplary embodiment of the present invention is described in more detail with reference to the accompanying drawings.

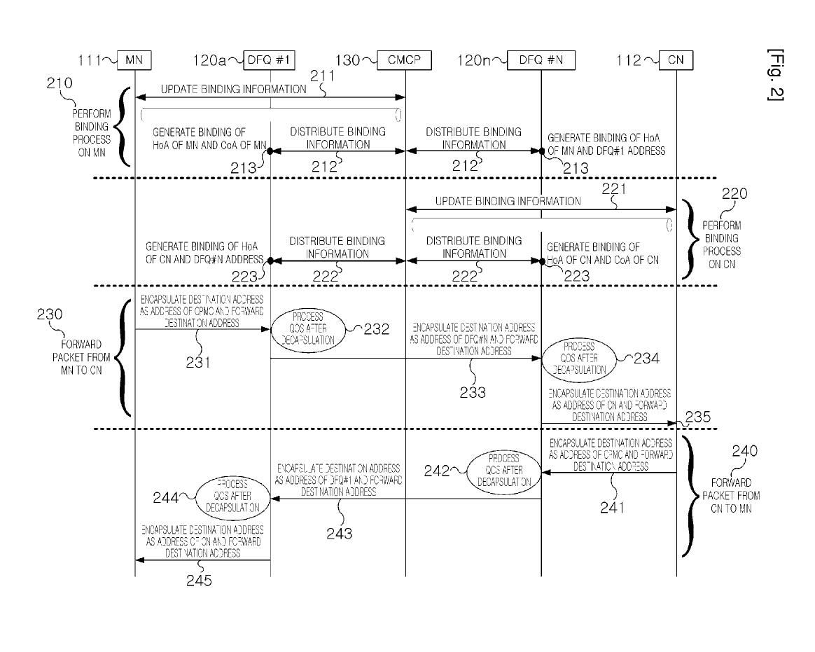

FIG. 2 is a diagram illustrating a method for providing session-based quality of service when a mobile node communicates with a moving correspondent node under a network environment using a host-based network layer mobility protocol based on tunneling mechanism according to one exemplary embodiment of the present invention.

As shown in FIG. 2, the method for providing session-based quality of service according to one exemplary embodiment of the present invention may include a step of performing a binding update process for the mobile node 111 (Step 210), a step of performing a binding update process for the correspondent node 112 (Step 220), a step of forwarding a packet from the mobile node 111 to the correspondent node 112 (Step 230) and a step of forwarding a packet from the correspondent node 112 to the mobile node 111 (Step 240).

First, the step of performing a binding process for the mobile node 111 (Step 210) is described in detail, as follows. In general, as in conventional host-based mobility protocols, the binding information that a mobile node 111 transfers the HoA of the mobile node 111 and CoA of the mobile node 111 as the binding information. However, according to one exemplary embodiment of the present invention, the central mobility control platform 130 registers the address of the access node 120a instead of the CoA of the mobile node 111 as the binding information of the mobile node 111.

In Step 211, the mobile node 111 sets a tunnel with the central mobility control platform 130 by updating the binding information with the central mobility control platform 130. That is, the mobile node 111 transfers a control message including the binding information to the central mobility control platform 130. Therefore, the central mobility control platform 130 updates the binding information of the mobile node 111 using the binding information in the received control message.

In Step 212, when the central mobility control platform 130 receives a packet from the mobile node 111, the central mobility control platform 130 encapsulates the packet with a destination address as an address of the access node 120a as destination address so that the packet may be transferred via the access node 120a to which the mobile node 111 is attached. In this time, in Step 212, the central mobility control platform 130 distributes the binding information of the mobile node 111 into the access nodes 120a to 120n in network. In this time, different kinds of binding information are supplied to the access node 120a to which the mobile node 111 is newly connected, and the other access nodes 120b to 120n. That is, a CoA of the mobile node 111 and the HoA of the mobile node 111 is supplied as the binding information to the access node 120a, but an address of the access node 120a to which the mobile node 111 is attached and the HoA of the mobile node 111 is supplied as the binding information to the other access nodes 120b to 120n.

Next, the binding update process for the correspondent node 112 is now described, as follows. This binding update process is performed in the same manner as in the binding update process for the mobile node 111.

In Step 221, when the central mobility control platform 130 receives a control message including binding information from the correspondent node 112, the central mobility control platform 130 updates the binding information of the correspondent node 112 using the binding information in the control message. That is, the central mobility control platform 130 encapsulates a destination address into an address of the access node 120n so that a packet can be transferred via the access node 120n providing access to the correspondent node 112. In this time, in Step 222, the central mobility control platform 130 distributes the binding information to all the access nodes 120 in network. In this time, different kinds of binding information are supplied to the access node 120n to which the correspondent node 112 is newly connected, and the other access nodes 120a to 120n-1. Here, a CoA of the correspondent node 112 and the HoA of the correspondent node 112 is supplied as the binding information to the access node 120n, and an address of the access node 120a to which the mobile node 111 is attached and the HoA of the mobile node 111 is supplied as the binding information to the other access nodes 120b to 120n-1.

Then, the step of forwarding a packet from the mobile node 111 to the correspondent node 112 (Step 230) is described in detail, as follows.

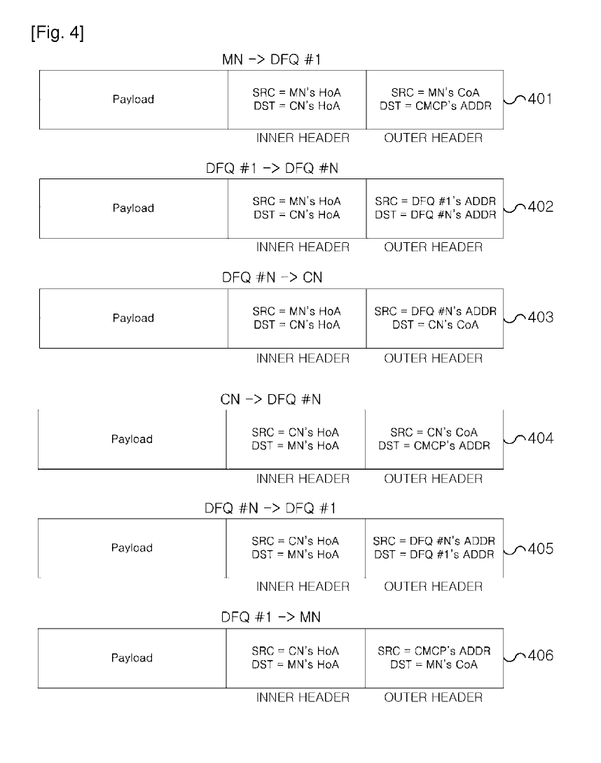

In Step 231, the mobile node 111 encapsulates a destination address into an address of the central mobility control platform 130, and then forwards the destination address to the access node 120a providing access to the mobile node 111 is attached to itself, as shown in a 401 packet format of FIG. 4.

As a result, in Step 232, when the access node 120a receives a packet, the access node 120a decapsulates an outer header of the received packet, and processes quality of service by means of the QoS table lookup. In Step 233, the access node 120a then forwards the packet to the access node 120n by means of the forwarding table lookup. In this time, when the binding information of the correspondent node 112 is supplied to the access node 120a in the step of performing a binding update process for the correspondent node 112 (Step 220), the access node 120a encapsulates and forwards the packet by setting an address of the access node 120n as a destination address according to the forwarding table lookup results. Here, a format of the forwarded packet is represented as shown in a 402 packet format of FIG. 4. In this case, when the correspondent node 112 is registered in advance, a packet is encapsulated with the CoA of the correspondent node 112, and forwarded, whereas when the correspondent node 112 is not registered in advance, a packet is forwarded without its encapsulation.

When the packet is supplied to the access node 120n as described in the steps for the operation of the access node 120a, the access node 120n decapsulates an outer header of the packet, and processes quality of service by means of the QoS table lookup in Step 234. In Step 235, the access node 120n then forwards the packet to the correspondent node 112 by means of the forwarding table lookup. In this time, when the binding information of the correspondent node 112 is supplied to the access node 120n through the binding distribution of the step of performing a binding update process for the correspondent node 112 (Step 220), the access node 120n encapsulates and forwards the packet by setting an address of the correspondent node 112 as the destination address according to the forwarding table lookup results. Here, a format of the forwarded packet is represented as shown in a 404 packet format of FIG. 4. Accordingly, the correspondent node 112 decapsulates a forwarding packet, and processes an internal packet.

Subsequently, the step of forwarding a packet from the correspondent node 112 to the mobile node 111 (Step 240) is now described in detail, as follows.

In Step 241, the correspondent node 112 encapsulates a packet having an outer header whose destination address is set as an address of the central mobility control platform 130 as shown in a 404 packet format of FIG. 4, and forwards the encapsulated packet to the access node 120n providing access to the correspondent node 112 itself. Here, a format of the forwarded packet is represented as shown in a 404 packet format of FIG. 4.

In Step 242, the access node 120n then decapsulates the outer header of the forwarded packet, and processes quality of service for the decapsulated packet by means of the QoS table lookup. In Step 243, the access node 120n forwards the decapsulated packet to the access node 120a by means of the forwarding table lookup. In this time, when the binding information of the mobile node 111 is supplied to the access node 120a through the binding distribution of the step of performing a binding update process for the mobile node 111 (Step 210), the access node 120a encapsulates and forwards the packet by setting an address of the access node 120a as the destination address. Here, a format of the forwarded packet is represented as shown in a 405 packet format of FIG. 4.

When the packet is supplied to the access node 120n in Step 244 as described in the steps for the operation of the access node 120b, the access node 120a decapsulates an outer header of the packet, and processes quality of service for the decapsulated packet by means of the QoS table lookup. In Step 245, the access node 120a then forwards the decapsulated packet to the mobile node 111 by means of the forwarding table lookup.

In this case, when binding information of the mobile node 111 is supplied to the access node 120a through the binding distribution of the step of performing a binding update process for the mobile node 111 (Step 210), the access node 120a encapsulates the packet by setting an address of the mobile node 111 as the destination address according to the forwarding table lookup results, and then forwards the encapsulated packet to the mobile node 111. Here, a format of the forwarded packet is represented as shown in a 406 packet format of FIG. 4.

Subsequently, the mobile node 111 decapsulates the packet received from the access node 120a, and processes an internal packet.

Then, a method for providing quality of service (QoS) under a network environment using a host-based network layer mobility protocol based on tunneling mechanism in the network for providing quality of service (QoS) according to another exemplary embodiment of the present invention is described in more detail with reference to the accompanying drawings.

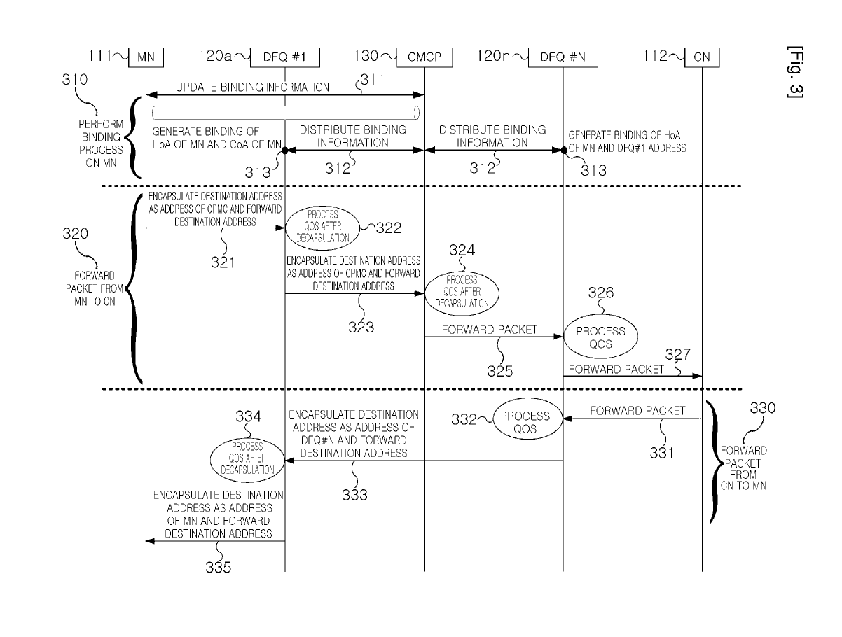

FIG. 3 is a diagram illustrating a method for providing session-based quality of service when a mobile node communicates with a fixed correspondent node under a network environment using a host-based network layer mobility protocol based on tunneling mechanism according to another exemplary embodiment of the present invention.

Referring to FIG. 3, the method for providing session-based quality of service according to another exemplary embodiment of the present invention may include a step of performing a binding update process for the mobile node 111 (Step 310), a step of forwarding a packet from the mobile node 111 to the correspondent node 112 (Step 320), and a step of forwarding a packet from the correspondent node 112 to the mobile node 111 (Step 333).

Steps 311 to 313 of the step of performing a binding update process for the mobile node 111 (Step 310) are performed in the same manner as described above in Step 211 to 213 of the method according to one exemplary embodiment of the present invention, and therefore their detailed descriptions are omitted for clarity.

Next, the step of forwarding a packet from the mobile node 111 to the correspondent node 112 (Step 320) is now described in detail, as follows.

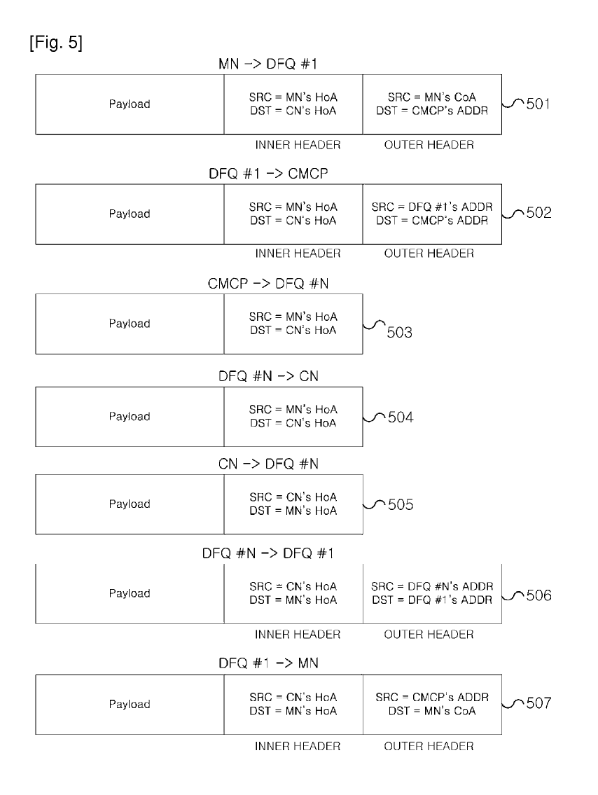

In Step 321, the mobile node 111 sets a destination address of an outer header of the packet, encapsulates the packet with an address of the central mobility control platform 130, and forwards the encapsulated packet to the access node 120a providing access to the mobile node 111 itself, as shown in a 501 packet format of FIG. 5.

In Step 322, the access node 120a then decapsulates the forwarded packet, and processes quality of service for the decapsulated packet by means of the forwarding table lookup and QoS table lookup. In this time, since the correspondent node 112 is a fixed node, there is no binding process for the correspondent node 112. As a result, since the binding information of the correspondent node 112 is not supplied to the access node 120a, the access node 120a simply forwards the forwarding table lookup results. Therefore, in Step 323, the access node 120a encapsulates a destination address into an address of the central mobility control platform 130, and forwards the packet to the central mobility control platform 130. In this time, a format of the forwarded packet is represented as shown in a 502 packet format of FIG. 5.

In Step 324, the central mobility control platform 130 then decapsulates the packet received from the access node 120a, and processes quality of service for the decapsulated packet according to the results of the forwarding table lookup and QoS table lookup. In Step 325, the central mobility control platform 130 forwards the packet to the access node 120b providing access to the correspondent node. Here, since the binding information is not present in the central mobility control platform 130 as described in the steps for the operation of the access node 120a, the access node 120b simply forwards the forwarding table lookup results. In this case, a format of the forwarded packet is represented as shown in a 503 packet format of FIG. 5.

Next, when the packet is supplied to the access node 120b in Step 326, the access node 120b processes quality of service for the packet by means of the forwarding table lookup and QoS table lookup. In Step 327, the access node 120b forwards the packet to the correspondent node 112. Here, since the correspondent node 112 is a fixed node, there is no binding process for the correspondent node 112. Since the binding information of the correspondent node 112 is not supplied to the access node 120b, the correspondent node 112 simply forwards the forwarding table lookup results. In this case, a format of the forwarded packet is represented as shown in a 504 packet format of FIG. 5. When the correspondent node 112 receives the packet, therefore, the correspondent node 112 decapsulates the packet, and processes an internal packet.

Subsequently, the step of forwarding a packet from the correspondent node 112 to the mobile node 111 (Step 333) is now described in detail, as follows.

In Step 331, the correspondent node 112 forwards the packet to the access node 120b providing access to correspondent node 112 itself without any tunneling, as shown in a 505 packet format of FIG. 5. As a result, when the packet is forwarded to the access node 120b providing access to the correspondent node 112 in Step 332, the access node 120b processes quality of service for the packet by means of the forwarding table lookup and QoS table lookup. In Step 333, the access node 120b forwards the packet to the access node 120a providing access to the mobile node 111. In this time, when the binding information of the mobile node 111 is supplied to the access node 120b through the binding distribution of the step of performing a binding process of the mobile node 111 (310), the access node 120b encapsulates and forwards the packet by setting an address of the access node 120a as the destination address according to the forwarding table lookup results. In this case, a format of the forwarded packet is represented as shown in a 506 packet format of FIG. 5.

When the packet is supplied to the access node 120a as described in the steps for the operation of the access node 120b, the access node 120a decapsulates an outer header of the access node 120a, and processes quality of service for the packet by means of the forwarding table lookup and QoS table lookup in Step 334. In Step 335, the access node 120a forwards the packet to the mobile node 111. In this time, when the binding information of the mobile node 111 is supplied to the access node 120a through distributing binding information of the mobile node 111 (310), the access node 120a encapsulates and forwards the packet by setting an address of the mobile node 111 as the destination address according to the forwarding table lookup results. In this case, a format of the forwarded packet is represented as shown in a 507 packet format of FIG. 5. The mobile node 111 decapsulates the packet received from the access node 120a, and processes an internal packet.

While the present invention has been shown and described in connection with the exemplary embodiments, it will be apparent to those skilled in the art that modifications and variations can be made without departing from the scope of the invention as defined by the appended claims.

1. A method for providing quality of service for mobile nodes in a quality of service (QoS)-providing system comprising a central mobility control platform and a plurality of access nodes providing access to a plurality of nodes, wherein any of the access nodes provide quality of service for traffic between the plurality of nodes, the method comprising:
performing a binding update process for a mobile node to generate binding information by the central mobility control platform;
distributing the binding information to a plurality of access nodes by the central mobility control platform;
forwarding a packet to an access node providing access to the mobile node using the distributed binding information after processing session-based QoS by an access node providing access to a correspondent node when the packet is received from the correspondent node; and
forwarding the packet to the mobile node using the distributed binding information after processing session=based QoS by the access node providing access to the mobile node.

2. The method of claim 1, wherein the central mobility control platform distributes, as the generated binding information, a care-of address and a home address of the mobile to the access node providing access to the mobile node and distributes, as the generated binding information, the home address of the mobile and an address of the access node providing access to the mobile node to the access node providing access to the correspondent node.

3. The method of claim 1, wherein the step of forwarding the packet to the access node providing access the mobile node comprises:
receiving the packet from the correspondent node, the packet being encapsulated with an address of the central mobility control platform as a destination address and a care-of address of the mobile node as a source address;
decapsulating an outer header of the received packet;
processing quality of service for the decapsulated packet;
encapsulating the decapsulated packet with the address of the access node providing access to the mobile node as a destination address and the address of the access node providing access to the correspondent node as a source address; and
forwarding the encapsulated packet to the access node providing access to the mobile node via the central mobility control platform.

4. The method of claim 1, wherein the step of forwarding the packet to the mobile node comprises:
encapsulating the packet with a care-of address of the mobile node as a destination address; and
forwarding the encapsulated packet to the mobile node.

5. A quality of service (QoS)-providing system, comprising:
a plurality of access nodes distributed-providing forwarding for a packet transferred between nodes and processing quality of service for the packet; and
a central mobility control platform updating binding information received from a mobile node to set a tunnel with the mobile node and distributing binding information of the mobile node to the plurality of access nodes.

6. The QoS-providing system of claim 5, wherein the access node providing access to the mobile node among the plurality of access nodes receives a packet from the mobile node, the packet being encapsulated with an address of the central mobility control platform as destination address and a CoA address of the mobile node as source address, decapsulates an outer header of the received packet, processes quality of service for the received packet, encapsulates the received packet with an address of the central mobility control platform as a destination address and an address of the access node as a source address, and forwards the encapsulated packet to the access node providing access to the correspondent node through the central mobility control platform.

7. The QoS-providing system of claim 6, wherein when a packet is received from the access node providing access to the correspondent node, the access node providing access to the mobile node among the plurality of access nodes decapsulates an outer header of the received packet, processes quality of service on the received packet, encapsulates the decapsulated packet with a care-of address of the mobile node as a destination address and an address of the access node as a source address, and forwards the encapsulated packet to the mobile node.
